(19) United States
(12) Patent Application Publication
(10) Pub. No.: US 2024/0110583 A1
(43) Pub. Date: Apr. 4, 2024

(54) MAGNETIC CONNECTOR

(71) Applicant: Tsz Yau YAU, Hong Kong (CN)

(72) Inventor: Tsz Yau YAU, Hong Kong (CN)

(21) Appl. No.: 18/469,682

(22) Filed: Sep. 19, 2023

(30) Foreign Application Priority Data
Sep. 29, 2022 (CN) 202222604419.0

(51) Int. Cl. F16B 1/00

(52) U.S. Cl. CPC F16B 1/00; F16B 2200/83

(57) ABSTRACT

The present application discloses a magnetic connector including two elements capable of detachably spliced to each other. The first element is provided with a guide groove entrance and a L-shaped guide groove. The second element is provided with a protrusion and a splicing column. The magnetic components are provided in the first element and the second element. The splicing column is introduced into the L-shaped guide groove from the guide groove entrance, reaches to the end along the horizontal section of the L-shaped guide groove, and then enters the vertical section of the L-shaped guide groove. The two elements are secured by the magnetic attraction between the magnetic components, such that the two elements can be tightly connected without sliding off.

### TECHNICAL FIELD

The present application relates to the field of tools/handicrafts/furniture/toys/jewelry. In particular, the present application relates to a magnetic connector having a certain flat shape/spatial shape/geometric three-dimensional structure formed by splicing pieces together. The magnetic connector can be used for splicing tools, handicrafts, furniture, jewelry, or toys.

### BACKGROUND

Connecting means for accessories on the current market is relatively simple. The structure of some connectors affects or even destroys the aesthetics of accessories. In some connectors, the aesthetics is preserved, but the connection is not sufficiently stable.

China Utility Model Patent No. CN214630465U discloses a connecting structure. A plug connector is inserted into a guide groove, is rotated along the guide groove until it reaches the inner end of the groove and is clamped onto a groove. Another example is a connecting structure disclosed in China Utility Model Patent No. CN215776010U. After sliding a lock block down to the bottom of a lock slot, a lock lever is rotated to secure the lock block at the bottom of the lock slot. Although the above two connecting structures are cheap to manufacture, relatively simple in structure, easy to operate and do not affect the aesthetics of products, these structures do not provide stable connection.

### SUMMARY

In order to solve the shortcomings in the existing technologies, the inventor of the present application has arrived at the present connecting assembly, which provides protrusions and guides at the connecting body to form the connecting assembly, and providing magnetic components inside the connecting elements to achieve stable connection of the assembly.

In view of the above, embodiments of the present invention are herein provided, with the objective of providing a connecting structure with enhanced stability while retaining the aesthetics of the finished product.

In order to achieve the objectives of the present application, a magnetic connector is provided in the present application.

According to the first aspect of the present application, the magnetic connector comprises a first element and a second element capable of detachably spliced to each other. The first element comprises: a first body and a first connecting body; the first connecting body is connected to the first body and is provided with a first cavity therein. The first connecting body comprises a guide groove entrance arranged on a peripheral edge of the first connecting body distal from the first body; and an L-shaped guide groove arranged on periphery of the first connecting body. The L-shaped guide groove comprises a horizontal section and a vertical section. One end of the horizontal section is connected to the guide groove entrance and an another end of the horizontal section is connected to the vertical section. The second element comprises: a second body and a second connecting body; the second connecting body is connected to the second body and is provided with a second cavity therein. The second connecting body comprises: a protrusion protruding from a side of the second body proximal to the second connecting body and is formed within the second cavity; and a splicing column extended from inner peripheral side of the second connecting body and is formed within the second cavity. A first magnetic component is installed within the first body, and an inner diameter of the first cavity is greater than or equal to an outer diameter of the protrusion. A second magnetic component is installed within the protrusion; wherein the splicing column of the second element is inserted into the guide groove entrance of the first element, and the splicing column, through the guide groove entrance, enters the L-shaped guide groove, and slides along the horizontal section of the L-shaped guide groove. When the splicing column reaches the end of the horizontal section of the L-shaped guide groove and enters the vertical section of the L-shaped guide groove, the first body having the first magnetic component and the protrusion having the second magnetic component abut against each other through the magnetic attraction between the first magnetic component and the second magnetic component, thereby the first element is spliced to the second element. In one embodiment, the first magnetic component is installed within the first body proximal to the first cavity, and the second magnetic part is installed within the protrusion distal from the second body.

According to the second aspect of the present application, the maximum distance from the vertical section of the L-shaped guide groove 100 to the base of the connecting body of the first element 50 is shorter than the maximum distance between the splicing column and the second body, to enable the splicing column to move along the vertical section of the L-shaped guide groove to increase the distance and to weaken the magnetic attraction between the first magnetic component and the second magnetic component, thereby separating the first element and the second element.

By adopting the technical solutions of the present application, two elements with special internal structural features can be conveniently connected, fixed and separated from each other, so that stability of the connection is enhanced and the aesthetics of the finished product can be retained.

### BRIEF DESCRIPTION OF DRAWINGS

The drawings described herein are merely for illustration purposes and are not intended to limit the scope of the present application in any way.

The present application will be described in detail with reference to the drawings and embodiments, in which:

FIG. 1A is a perspective view of the structure of a first element according to the first embodiment of the present invention.

FIG. 1B is a front view of the structure of the first element according to the first embodiment of the present invention.

FIG. 1C is a bottom view of the structure of the first element according to the first embodiment of the present invention.

FIG. 1D is a cross-sectional view of the structure of the first element according to the first embodiment of the present invention.

FIG. 2A is a cross-sectional view of the first element and the second element of the first embodiment of the present invention being spliced firmly, wherein the guide groove entrance and the L-shaped guide groove of the first element are those in accordance with the first embodiment of the present invention.

FIG. 2B is a perspective view of the first element and the second element of the first embodiment of the present invention being spliced firmly, wherein the guide groove entrance and the L-shaped guide groove of the first element are those in accordance with the first embodiment of the present invention.

FIG. 3A is a perspective view of the structure of a second element according to the present invention.

FIG. 3B is a top view of the structure of the second element according to the present invention.

FIG. 3C is a cross-sectional view of the structure of a second element according to the present invention.

FIG. 4A is a front view of the structure of a first element according to the second embodiment of the present invention.

FIG. 4B is a perspective view of the structure of the first element according to the second embodiment of the present invention.

FIG. 5A is a front view of the structure of a first element according to the third embodiment of the present invention.

FIG. 5B is a perspective view of the structure of a first element according to the third embodiment of the present invention.

FIG. 6A is a front view of the structure of a first element according to the fourth embodiment of the present invention.

FIG. 6B is a perspective view of the structure of a first element according to the fourth embodiment of the present invention.

FIG. 7A is a front view of the structure of a first element according to the fifth embodiment of the present invention.

FIG. 7B is a perspective view of the structure of a first element according to the fifth embodiment of the present invention.

FIG. 8A is a front view of the structure of a first element according to the sixth embodiment of the present invention.

FIG. 8B is a perspective view of the structure of a first element according to the sixth embodiment of the present invention.

FIG. 9A is a front view of the structure of a first element according to the seventh embodiment of the present invention.

FIG. 9B is a perspective view of the structure of a first element according to the seventh embodiment of the present invention.

FIG. 10A is a front view of the structure of a first element according to the eighth embodiment of the present invention.

FIG. 10B is a perspective view of the structure of a first element according to the eighth embodiment of the present invention.

FIG. 11A is a front view of the structure of a first element according to the ninth embodiment of the present invention.

FIG. 11B is a perspective view of the structure of a first element according to the ninth embodiment of the present invention.

FIG. 12A is a front view of the structure of a first element according to the tenth embodiment of the present invention.

FIG. 12B is a perspective view of the structure of a first element according to the tenth embodiment of the present invention.

FIG. 13A is a front view of the structure of the first element according to the first embodiment of the present invention, in which the first body and the first connecting body are detachably connected.

FIG. 13B is a front view of the structure of the first element according to the first embodiment of the present invention, in which the first body and the first connecting body are detachably connected.

### NUMERAL REFERENCES

50 first element
51 second element
100 L-shaped guide groove
101 splicing column
102 guide groove entrance
103 first magnetic component
104 protrusion
105 second magnetic component

### DETAILED DESCRIPTION OF THE INVENTION

The following description is merely exemplary in nature and is not intended to limit disclosure, application, or uses of the present invention.

The magnetic connector of the present application comprises two core features: a L-shaped guide groove and a first magnetic component in a first element, and a splicing column and a second magnetic component in a second element. The drawings show various embodiments of the present application and are included to illustrate practical products of various embodiments.

The magnetic connector of the present invention includes various embodiments of the L-shaped guide grooves 100 as shown in the figures. Splicing column 101 is inserted into the L-shaped guide groove 100 to detachably spliced together to form the desired magnetic connector. The present magnetic connector can be used in toys, tools, furniture, handicrafts, etc. The elements of the present magnetic connector are easy to plug in and plug out and remain firmly connected after a long period of use. The present connector is simple in structure, good for mass production and with wide applications.

The material for forming the L-shaped guide groove 100 is not specifically limited in this application, which may be a metal material or a non-metal material. The metal material for forming the L-shaped guide groove 100 may be any metal material suitable for forming the L-shaped guide groove 100, including but not limited to iron, steel, aluminum, copper, aluminum alloy, copper alloy and the like. The material for forming the L-shaped guide groove 100 may also be magnetic, which strengthens the connection. The non-metal material for forming the L-shaped guide groove 100 may be any non-metal material suitable for forming the L-shaped guide groove 100, including but not limited to wood, glass, ceramics, plastics and the like.

In the following description, according to one embodiment of the present application, a horizontal section in the L-shaped guide groove 100 of the first element 50 extends in a plane (i.e. horizontal direction) perpendicular to the vertical axis of the first element 50, and a vertical section in the L-shaped guide groove 100 of the first element 50 extends along the vertical axis (i.e. vertical direction) of the first element 50.

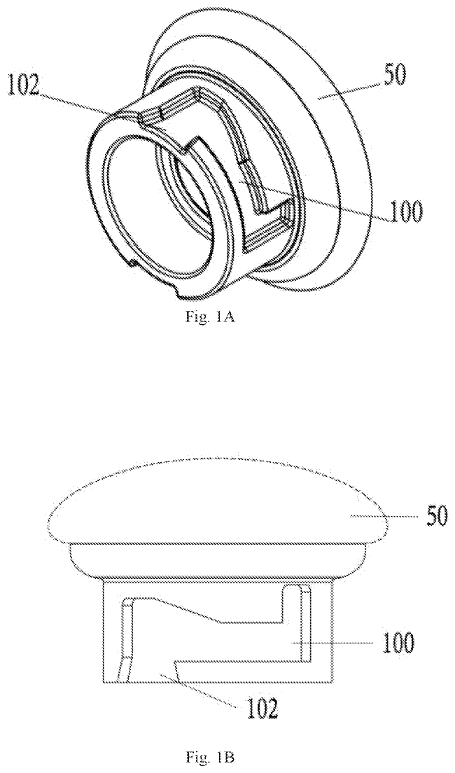

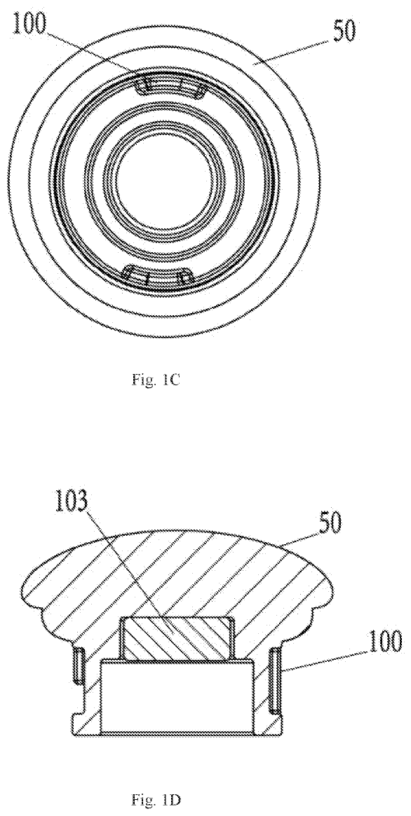

According to one embodiment of the present application, as shown in FIGS. 1A to 1D, the first element 50 comprises an L-shaped guide groove 100 which is etched inwardly from a lower peripheral surface of the first element. Interior of the first element 50 has a stepped cylindrical shape. The inner diameter of the upper part of the first element is a cylinder having a first diameter on which the first magnetic component 103 is installed, and the inner diameter of the lower part of the first element is a cylinder having a second diameter that mates with the protrusion 104 of the inner base of the second element 51. The relationship is that the first diameter is smaller than the second diameter.

One end of the L-shaped guide groove 100 is connected to the guide groove entrance 102 proximal to the base of the element 50 into which the splicing column 101 is inserted.

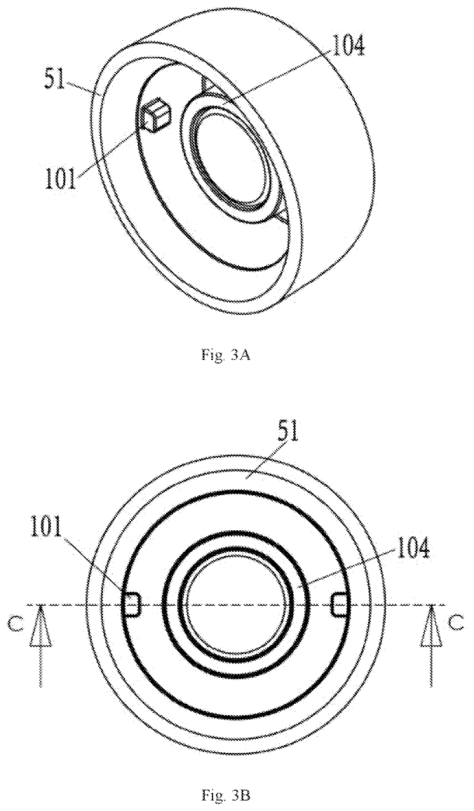

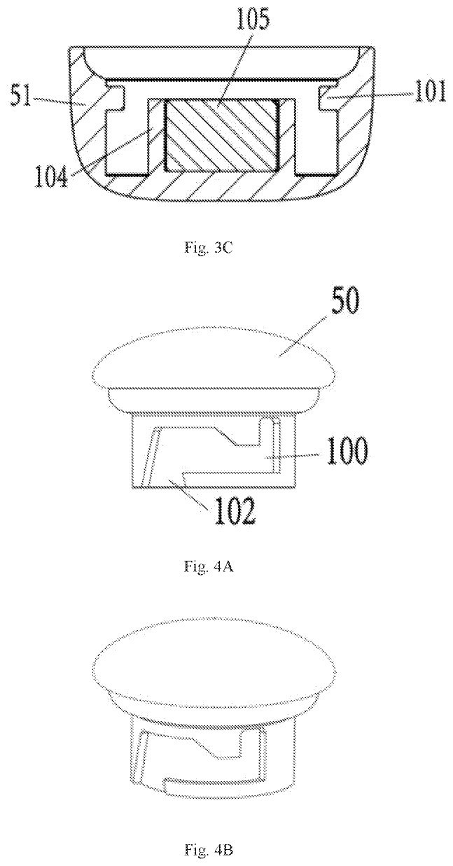

As shown in FIGS. 3A to 3C, the connecting body of the second element 51 includes two splicing columns 101 and a protrusion 104 protruding from the inner base of the second element 51. The interior of the connecting body of the element 51 is hollow and cylindrical for mating with the first element 50.

Splicing columns 101 are arranged on the inner wall of the second element, the two splicing columns are arranged on the same level. The extended height of the splicing column 101 extending from the inner peripheral side of the connecting body of the element 51 is shorter than or equal to the depth of the L-shaped guide groove 100 of the connecting body of the first element 50. The vertical height at which the splicing column 101 is located (herein refers to as the maximum distance between splicing column 101 and the second body, that is, the vertical distance between portion of the splicing column 101 furthest away from the second body and the surface of the second body) is greater than the maximum distance between the vertical section of L-shaped guide groove 100 and the base of the connecting body of the first element 50 (herein refers to as the vertical distance between the end of vertical section of L-shaped guide groove 100 furthest away from the base of the connecting body of the first element 50 and the base of the connecting body of the first element 50). The widths of the splicing column 101 and the L-shaped guide groove 100 are substantially the same, to prevent relative sliding when the first element 50 and the second element 51 are spliced.

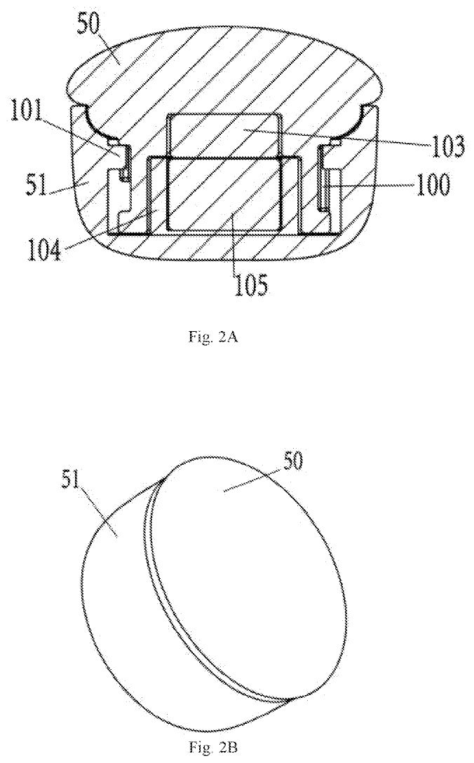

The splicing and separation of the first element 50 and the second element 51 will be described below with reference to FIGS. 2A and 2B.

According to one embodiment of the present application, the first element 50 comprises a first body and a first connecting body; the first connecting body is connected to the first body and is provided with a first cavity therein. The first connecting body comprises a guide groove entrance 102 arranged on a peripheral edge of the first connecting body distal from the first body; and a L-shaped guide groove 100 comprises a horizontal section and a vertical section, wherein one end of the horizontal section is connected to the guide groove entrance and an another end of the horizontal section is connected to the vertical section. The second element 51 comprises a second body and a second connecting body; the second connecting body is connected to the second body and is provided with a second cavity therein. The second connecting body comprises a protrusion 104 protruding from a side of the second body proximal to the second connecting body and is formed within the second cavity; and a splicing column 101 extended from inner peripheral side of the second connecting body and is formed within the second cavity.

In one embodiment, the first body may be connected to the first connecting body by integral molding or detachable connection. FIGS. 13A and 13B show the first body and the first connecting body are connected by detachable connection. It can be understood by those skilled in the art that the first element may be jewelry, toy, handicrafts or related parts in the furniture field. The first element of the present invention is applicable to different functional components and diversity of products that the present invention can be implemented in is enhanced. In another embodiment, the second body and the second connecting body or the protusion 104 may be connected by integral molding or detachable connection.

A first magnetic component 103 is arranged in the first body and proximal to the first cavity. The inner diameter of the first cavity is greater than or equal to the outer diameter of the protrusion 104, so that the protrusion 104 is able to insert into the first cavity accordingly. Inside the protrusion 104 is a second magnetic component 105 which is arranged on the side of the protrusion 104 distal from the second body.

The splicing of the first element and the second element is implemented in the following ways: the splicing column 101 of the second element 51 is inserted into the guide groove entrance 102 of the first element 50, the splicing column 101 enters the L-shaped guide groove 100 through the guide groove entrance 102 and slides along the horizontal section of the L-shaped guide groove 100. When the splicing column 101 reaches to the end of the horizontal section of the L-shaped guide groove 100 and enters the vertical section of the L-shaped guide groove 100, the first magnetic component 103 in the first body and the second magnetic component 105 in the protrusion 104 abut against each other through the magnetic attraction between the first magnetic component 103 and the second magnetic component 105, and the magnetic attraction between the magnetic components secures the attachment of the two elements.

Accordingly, the splicing of the first element 50 and the second element 51 is achieved.

The first element and the second element are separated in the following ways: since the maximum distance between the vertical section of the L-shaped guide groove 100 and the base of the connecting body of the first element 50 is less than the maximum distance between the splicing column 101 and the second body, the splicing column 101 is able to move along the vertical section of the L-shaped guide groove 100 to increase the distance between the two magnetic components and in turns weakens the attraction between first magnetic component 103 and the second magnetic component 105. Then, the splicing column 101 of the second element 51 enters the horizontal section of the L-shaped guide groove and continues to slide or rotate along the horizontal section of the L-shaped guide groove 100, and finally exits from the first connecting body of the first element 50 through the guide groove entrance 102 in connection to the L-shaped guide groove 100, thereby the first element 50 is separated from the second element 51.

Furthermore, in another embodiment, the L-shaped guide groove 100 and the guide groove entrance 102 in the present invention may have many alternative embodiments, which will be described one by one with reference to FIGS. 1A to 1D and 4A to 12B.

### First Embodiment

Referring to FIGS. 1A to 1D, a L-shaped guide groove 100 and a guide groove entrance 102 according to the first embodiment of the present invention are shown. The guide groove entrance 102 has a trapezoidal shape and opens from the wider end thereof. The first section of the L-shaped guide groove 100 is a horizontal section. The width of the horizontal section which meets with the guide groove entrance 102 is larger relatively and is maintained for some lengths. The width of the horizontal section gets smaller gradually. The second section of the L-shaped guide groove 100 is a vertical section for mating with the splicing column.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Second Embodiment

Referring to FIGS. 4A and 4B, a L-shaped guide groove 100 and a guide groove entrance 102 according to the second embodiment of the present invention are shown. The guide groove entrance 102 has a trapezoidal shape and opens from the wider end thereof. The first section of the L-shaped guide groove 100 is a horizontal section. The horizontal section has a wider width where it meets with the guide groove entrance 102 and extends in the horizontal direction of the trapezoidal guide groove entrance, maintaining the width for a certain length. The width of the horizontal section gets smaller gradually. The second section of the L-shaped guide groove 100 is a vertical section for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic parts.

### Third Embodiment

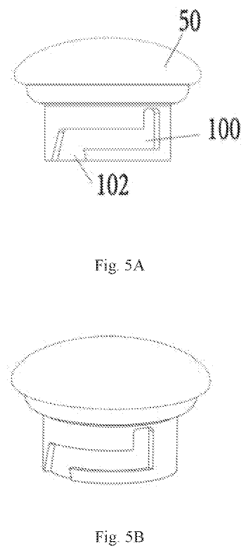

Referring to FIGS. 5A and 5B, a L-shaped guide groove 100 and a guide groove entrance 102 according to the third embodiment of the present invention are shown. The guide groove entrance 102 has a trapezoidal shape and opens from the wider end thereof. The first section of the L-shaped guide groove 100 is a horizontal section. The horizontal section is connected to the guide groove entrance 102 along the horizontal direction of the guide groove entrance. The second section of the L-shaped guide groove 100 is a vertical section for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Fourth Embodiment

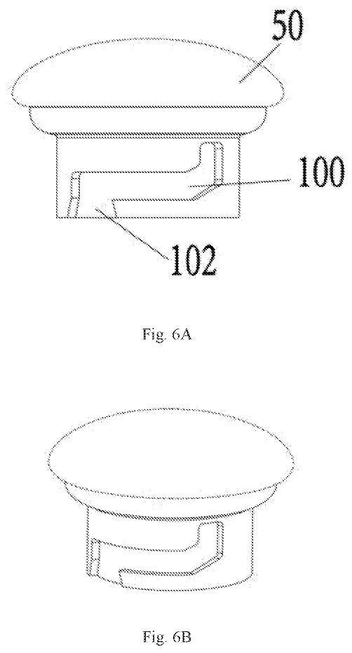

Referring to FIGS. 6A and 6B, a L-shaped guide groove 100 and a guide groove entrance 102 according to the fourth embodiment of the present invention are shown. The guide groove entrance 102 has a trapezoidal shape and opens from the wider end thereof. The first section of the L-shaped guide groove 100 is a horizontal section and is connected to the shorter side of the guide groove entrance 102 and extends a certain length in the horizontal direction at the same width. The second section of the L-shaped guide groove 100 is a vertical section for mating with the splicing column 101. The end of the first section inclines upward at a certain angle and extends to connect to the second section of the guide groove.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Fifth Embodiment

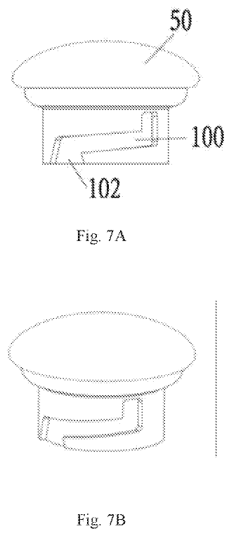

Referring to FIGS. 7A and 7B, a L-shaped guide groove 100 and a guide groove entrance 102 according to the fifth embodiment of the present invention are shown. The guide groove entrance 102 has a trapezoidal shape and opens from the wider end thereof. The first section of the L-shaped guide groove 100 is connected to the guide groove entrance 102 in the horizontal direction uniformly. The first section rotates at a certain angle counterclockwise in the horizontal direction to meet the second section, and its width tapers slightly along the horizontal direction. The second section of the L-shaped guide groove 100 is a vertical section for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Sixth Embodiment

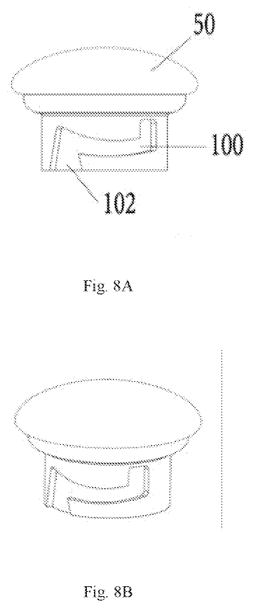

Referring to FIGS. 8A and 8B, a guide groove and a guide groove entrance according to the sixth embodiment of the present invention are shown. The guide groove entrance 102 has a trapezoidal shape and opens from the wider end thereof. The L-shaped guide groove 100 meets the guide groove entrance 102 uniformly in a horizontal manner. The first section is arched with the center bent downward and its width tapers slightly along the horizontal direction. The second section of the L-shaped guide groove 100 is a vertical section for mating with the splicing column.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Seventh Embodiment

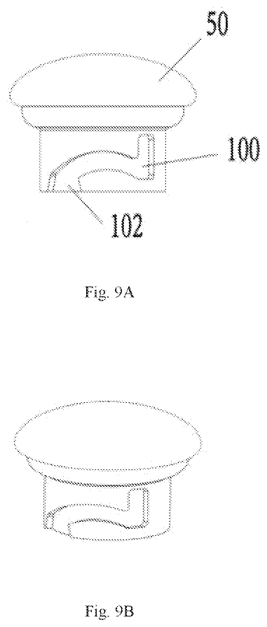

Referring to FIGS. 9A and 9B, a L-shaped guide groove 100 and a guide groove entrance 102 according to the seventh embodiment of the present invention are shown. The guide groove entrance 102 has a trapezoidal shape and opens from the wider end thereof. The first section of the L-shaped guide groove 100 meets the guide groove entrance 102, and is arched with the center bent upwards, and its width tapers slightly along the horizontal direction. The second section of the L-shaped guide groove 100 is a vertical section, and the lower half section is connected to the first section of the L-shaped guide groove 100 for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Eighth Embodiment

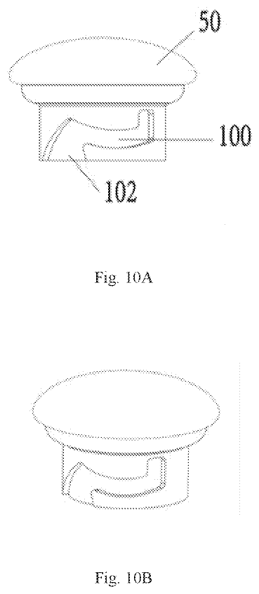

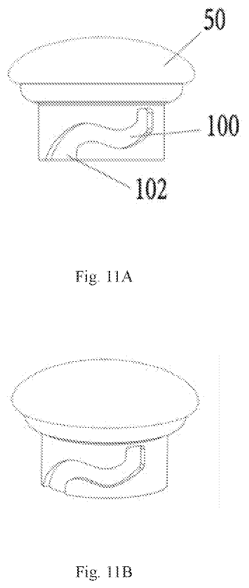

Referring to FIGS. 10A and 10B, a L-shaped guide groove 100 and a guide groove entrance 102 according to the eighth embodiment of the present invention are shown. The left and right sides of the guide groove entrance 102 are arc-shaped and opens from the wider end thereof. The first section of the L-shaped guide groove 100 meets the left edge of the guide groove entrance 102 and extends for a certain length. The first section is arched with the center bent downward. The second section of the L-shaped guide groove 100 is a vertical section, and the lower half section is connected to the first section of the L-shaped guide groove 100 for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Ninth Embodiment

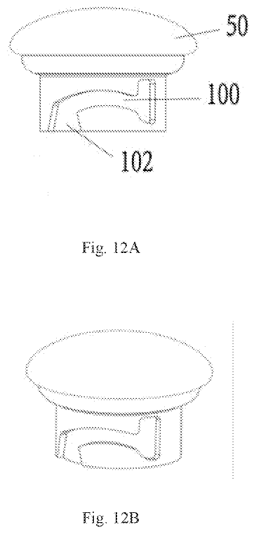

Referring to FIGS. 11A and 11B, a L-shaped guide groove 100 and a guide groove entrance 102 according to the ninth embodiment of the present invention are shown. The first section of the guide groove is wavy and smoothly meets the guide groove entrance. The second section of the L-shaped guide groove 100 is a vertical section for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

### Tenth Embodiment

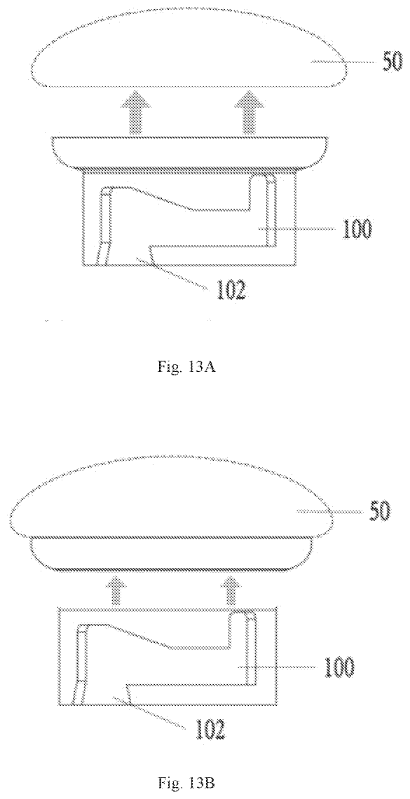

Referring to FIGS. 12A and 12B, a L-shaped guide groove 100 and a guide groove entrance 102 according to the tenth embodiment of the present application are shown. The left and right sides of the guide groove entrance 102 are arc-shaped and opens at the wider end thereof. The first section of the L-shaped guide groove 100 meets the guide groove entrance 102, and is arched with the center bent upwards, and its width tapers slightly along a horizontal direction. The second section of the L-shaped guide groove 100 is a vertical section with an arc-shaped at the base for mating with the splicing column 101.

After the splicing column 101 of the second element 51 enters the L-shaped guide groove 100 through the guide groove entrance 102, the splicing column 101 is rotated along the first section of the L-shaped guide groove 100 to enter the second section and is secured by mutual attraction of two magnetic components.

By adopting the technical solutions of the present application, two elements with special internal structural features can be conveniently connected, fixed and separated from each other, so that stability of the connection is enhanced, and the aesthetic of the finished product can be retained.

It should be noted that, according to the embodiments of the present application, in addition to accessories, the first element 50 including the L-shaped guide groove 100 and the second element 51 including the splicing column 101 and the protrusion 104 may also be used as components in the fields of toys, handicrafts and furniture, which illustrates the magnetic connector in the present application can also be applied to the fields of toys, handicrafts and furniture to provide simple and stable connection between two or more components.

1. A magnetic connector, comprising:
a first element (50) and a second element (51) capable of detachably spliced to each other,
wherein the first element (50) comprises:
a first body; and
a first connecting body connected to the first body and provided with a first cavity therein, wherein said first connecting body comprises a guide groove entrance (102) arranged on a peripheral edge of the first connecting body that is distal from the first body and a L-shaped guide groove (100) arranged on peripheral of the first connecting body, wherein the L-shaped guide groove (100) comprises a horizontal section and a vertical section, one end of the horizontal section is connected to the guide groove entrance (102) and an another end of the horizontal section is connected to the vertical section;
wherein the second element (51) comprises:
a second body; and
a second connecting body connected to the second body and provided with a second cavity therein, wherein said second connecting body comprises a protrusion (104) protruding from a side of the second body that is proximal to the second connecting body and is formed within the second cavity and a splicing column (101) extended from inner peripheral side of the second connecting body and is formed within the second cavity;
characterized in that a first magnetic component (103) is installed within the first body, and an inner diameter of the first cavity is greater than or equal to an outer diameter of the protrusion (104); a second magnetic component (105) is installed within the protrusion (104); and
wherein, the splicing column (101) of the second element (51) is inserted into the guide groove entrance (102) of the first element (50), and the splicing column (101) passes through the guide groove entrance (102), enters the L-shaped guide groove (100), and slides along the horizontal section of the L-shaped guide groove (100), when the splicing column (101) reaches to the end of the horizontal section of the L-shaped guide groove (100) and enters the vertical section of the L-shaped guide groove (100), the first body having the first magnetic component (103) and the protrusion (104) having the second magnetic component (105) abut against each other through magnetic attraction between the first magnetic component (103) and the second magnetic component (105), thereby the first element (50) is spliced to the second element (51).

2. The magnetic connector according to claim 1, characterized in that, the maximum distance between the vertical section of the L-shaped guide groove (100) and the base of the first connecting body is shorter than the maximum distance between the splicing column (101) and the second body, to enable the splicing column to move along the vertical section of the L-shaped guide groove to increase the distance and to weaken the magnetic attraction between the first magnetic component (103) and the second magnetic component (105) and thereby the first element (50) is separated from the second element (51).

3. The magnetic connector according to claim 1, characterized in that, depth of the guide groove entrance (102) and the guide groove (100) is greater than or corresponds to extended height of the splicing column (101), the horizontal section of the L-shaped guide groove (100) is parallel to the base of the first connecting body and the vertical section of the L-shaped guide groove (100) is arranged vertically upward relative to the base of the first connecting body

4. The magnetic connector according to claim 1, characterized in that, depth of the guide groove entrance (102) and the guide groove (100) is greater than or corresponds to extended height of the splicing column (101), the horizontal section of the L-shaped guide groove (100) is not parallel to the base of the first connecting body and the vertical section of the L-shaped guide groove (100) is arranged vertically upward relative to the base of the first connecting body.

5. The magnetic connector according to claim 4, characterized in that, the horizontal section of the L-shaped guide groove (100) comprises a straight section, an arc-shaped section or a S-shaped section.

6. The magnetic connector according to claim 1, characterized in that, the first body is connected to the first connecting body by integral molding or a detachable connection; and the second body is connected to the second connecting body or the protrusion (104) by integral molding or a detachable connection.

7. The magnetic connector according to claim 1, characterized in that, the magnetic connector comprises one or more of the guide groove entrance (102) and the L-shaped guide groove (100) on the first element (50) and a complementary splicing column (101) on the second element (51).

8. The magnetic connector according to claim 1, characterized in that, the first element (50) and the second element (51) are made of metal.

9. The magnetic connector according to claim 1, characterized in that, the first element (50) and the second element (51) are made of wood.

10. The magnetic connector according to claim 1, characterized in that, the first element (50) and the second element (51) are made of plastic.
